(19) United States
(12) Patent Application Publication
(10) Pub. No.: US 2016/0297998 A1
(43) Pub. Date: Oct. 13, 2016

(54) CHEMICAL MACHNICAL POLISHING SLURRY

(71) Applicant: Min Zhong, Shanghai (CN)

(72) Inventor: Min Zhong, Shanghai (CN)

(21) Appl. No.: 15/033,101

(22) PCT Filed: Jul. 31, 2014
(86) PCT No.: PCT/CN2014/083365

§ 371 Date: Apr. 28, 2016

(30) Foreign Application Priority Data
Dec. 31, 2013 (CN) 201310753961.5

(51) Int. Cl. C09G 1/02; C23F 3/00; C09K 3/14

(52) U.S. Cl. CPC C09G 1/02; C09K 3/1463; C23F 3/00

(57) ABSTRACT

A chemical mechanical polishing slurry including chemical solution, and organic and inorganic particles suspended in the chemical solution is disclosed. The organic particles are formed by polymerized monomers with long chains and/or nebular core-shells; such shapes with increased surface areas can enlarge the contact areas between the polished materials and the organic particles. The chemical solution also includes surfactants attached to the surfaces of the organic particles and the inorganic particles, which separates the organic particles from the inorganic particles. The chemical mechanical polishing slurry has the advantages of both the organic particles and inorganic particles so as to reduce the polishing scratches and enhance the polishing efficiency.

### CROSS-REFERENCE TO RELATED APPLICATION

This application claims the priority benefit of International Patent Application Serial No. PCT/CN2014/083365, filed Jul. 31, 2014, which is related to and claims the priority benefit of China patent application serial No. 201310753961.5, filed Dec. 31, 2013. The entirety of each of the above-mentioned patent applications is hereby incorporated by reference herein and made a part of this specification.

### FIELD OF THE INVENTION

The present invention generally relates to the field of integrated circuit manufacturing technology and more particularly to a chemical mechanical polishing slurry.

### BACKGROUND OF THE INVENTION

Chemical mechanical polishing (CMP) is one of the important semiconductor manufacturing processes which realizes the planarization of the entire wafer surface by grinding and removing the semiconducting materials, insulating materials or metal materials on the patterned surface of the wafer. During the polishing procedure, the wafer to be polished is fixed on a polishing carrier with its surface connected to a polishing pad, and a polishing slurry comprised of abrasive particles and chemical solution is supplied to the polishing pad. The chemical materials in the polishing slurry oxidize the material on the wafer surface to form a softer oxide layer, and then the contact friction among the polishing pad, the abrasive particles and the wafer subsequently remove the softer oxide layer so as to expose a fresh surface; such oxidization and removal processes are performed successively again and again until the raised parts of the wafer surface are removed completely, and the surface planarization of the wafer is achieved.

The abrasive particles in the polishing slurry have a great effect on the polishing rate and the final polished surface quality. With the reduction of the process node and the growing application of low-k materials as well as aluminum in the metal gate process, the polished surface is expected to have no scratches or abrasive particle residues, which brings higher and higher requirements to the CMP process. However, the hardness of the conventional inorganic abrasive particles such as the fumed silicon dioxide or the cerium oxide is relative high and the content of the abrasive particles in the polishing slurry for polishing dielectric materials is great (>10%), which may cause scratches to the polished surface of the soft low-k materials and metal materials of lower hardness, such as copper and aluminum. Studies have indicated that the organic soft abrasive particles can reduce the scratches on the wafer surface. Generally, the organic particle is spherical, as shown in FIG. 1, which is a view of the structure of the organic particle in the conventional polishing slurry. However, the polishing efficiency of such slurry is very low due to the low hardness of the single sphere organic particle. Recently compound abrasive particles having an organic particle as a core and an inorganic particle layer covering or adhered to the outer surface of the organic particle have attracted more and more attention, and related patent applications are increasingly filed. Please referring to FIG. 2A which illustrates the conventional compound abrasive particles disclosed in the Chinese patent application CN1616573A, inorganic particles 1 are attached to the surface of an organic resin particle 2. However, the manufacturing process of such abrasive particle is complicated and the distribution of the inorganic particles 1 on the organic particle 2 is difficult to control. The Chinese patent application CN1082400A disclosed another compound abrasive particle comprising an organic nanoparticle 4 as a core and a cerium dioxide layer 3 as a shell formed on the surface of the organic nanoparticle, as shown in FIG. 2B. However, the fabrication of such compound abrasive particles is complex and costs a great deal.

Accordingly, how to make the polishing slurry have the advantages of both the organic particles and the inorganic particles to be less prone to cause the scratches while achieving high polishing rate is one of the problems need to be solved by those skilled in the art.

### BRIEF SUMMARY OF THE DISCLOSURE

Therefore, an objective of the present invention is to provide a chemical mechanical polishing slurry including separate organic and inorganic particles in which the organic particles are formed by polymerized monomers with long chains and/or nebular core-shells, so as to reduce the polishing scratches and residues on the surface of the polished materials, increase the contact areas between the polishing slurry and the polished materials, and ensure relative high polishing rate.

To achieve these and other advantages and in accordance with the objective of the invention, the invention provides a chemical mechanical polishing slurry. The chemical mechanical polishing slurry includes chemical solution, and organic particles and inorganic particles suspended in the chemical solution. Wherein, the organic particles are formed by polymerized monomers with long chains and/or nebular core-shells; the chemical solution contains surfactants attached to the surfaces of the organic particles and the inorganic particles which separate the organic particles from the inorganic particles.

The advantages of the chemical mechanical polishing slurry mentioned above are as follows: firstly, the contact areas between the polished materials and the organic particles are enlarged due to the increased surface areas of the long chain or nebular core-shell structures; secondly, the organic particles and the inorganic particles are separated from each other by utilizing the surfactants properties, such as the hydrophobicity and hydrophilicity, or the charge repulsion. Therefore, the advantages of both the organic and inorganic particles can be fully used to reduce the polishing scratches and residues and increase the polishing rate. It is noted that in the present invention, the organic particles formed by the polymerized monomers have a shape of long chains and their combination, and/or monomer-polymerized nebular core-shells and their combination, and/or the combination of the monomer-polymerized long chains and nebular core-shells.

Preferably, the content of the organic particles is three to ten times larger than that of the inorganic particles; and the total content of the organic particles and the inorganic particles in the chemical mechanical polishing slurry is from 5 wt % to 25 wt %. Since the content of the organic particles is increased while the content of the inorganic particles is reduced, the occurrence of the polishing scratches and residues on the surface of the polished materials can be effectively suppressed.

Preferably, the molecular weight of the monomers in the organic particle is from 500 to 50000 and the size of the organic particles is from 50 nm to 400 nm.

Preferably, the nebular core-shell structure is composed of a nebular shell and a core, and the Shore hardness of the shell is lower than that of the core. Optionally, the Shore hardness of the shell is from 80 to 90A and that of the core is higher than 80A and lower than 130A. Since the Shore hardness of the shell is lower than that of the core, the polishing scratches and residues on the surface of the polished materials can be greatly reduced and the decreased polishing efficiency due to the excessive softness of the organic materials can be improved.

Preferably, in the long chain structure, each of the monomers has multiple material layers of different hardness distributed from the outer surface to the inner center, wherein the outmost material layer has the lowest hardness. Optionally, the Shore hardness of the outmost material layer is from 60A to 90A and the Shore hardness of the inner center material layer of is higher than 60A and not higher than 130A.

Preferably, the material of the organic particles is selected from at least one of the following: polyethylene, polypropylene, polyvinyl chloride, polystyrene, acrylonitrile-butadiene-styreneterpolymer, polycarbonate, polyphenylene, polyphenylene sulfide, polymethyl-methacrylate, polyethylene terephthalate, polybutylene terephthalate, polyurethane, polyetheretherketon, phenol formaledlyde, urea-formaldehyde resin, and epoxy resin.

Preferably, the surfactants have both the hydrophobicity and hydrophilicity.

Preferably, the size of the inorganic particles is from 30 nm to 200 nm; the material of the inorganic particles is selected from at least the one of alumina, titanium oxide, zirconium oxide, silicon oxide, cerium oxide, and tantalum oxide.

Preferably, the organic particles are formed by bulk polymerization, suspension polymerization, emulsionpolymerization, solution polymerization, ionic poly-merization, coordination polymerization, melt polymerization, interfacial polyconden-sation and interfacial polycondensation.

According to the chemical mechanical polishing slurry of the present invention, the organic particles and the inorganic particles are suspended in the chemical solution. The organic particles and the inorganic particles are separated by the surfactants attached to their surfaces. Since the polymerized monomers of the organic particles are designed to be in the shape of long chains and their combination, and/or nebular core-shells and their combination, and/or the combination of the long chains and nebular core-shells, the contact areas between the polished materials and the organic particles can be enlarged by the increased surface area of the organic particles. Particularly, the shell of the nebular core-shell structure or the outmost material layer of the monomer in the long chain structure is the softest in the organic particle, which suppresses the occurrence of the polishing scratches and prevents the organic particle from being much too soft to reduce the polishing efficiency. Furthermore, the content of the organic particles is adjusted to be higher than that of the inorganic particles so that the residues on the surfaces of the polished materials are decreased due to the content reduction of the inorganic particles. In addition, since the organic particles are separated from the inorganic particles, the polishing slurry of the present invention can take advantages of not only the organic particles to reduce the polishing scratches on the materials surfaces, but also the inorganic particles to enhance the polishing rate and the polishing efficiency. Moreover, the chemical mechanical polishing slurry of the present invention can be easily fabricated with a low production cost.

### BRIEF DESCRIPTION OF THE DRAWINGS

FIG. 1 is a view illustrating the structure of the organic particle in the conventional polishing slurry;

FIGS. 2 A and 2B are views illustrating the structures of the conventional compound abrasive particles;

FIG. 3 is a schematic diagram illustrating the composition of the chemical mechanical slurry of the present invention;

FIGS. 4 to 6 are views illustrating the organic particles according to the first embodiment of the present invention;

FIG. 7 is a view illustrating the organic particle according to the second embodiment of the present invention.

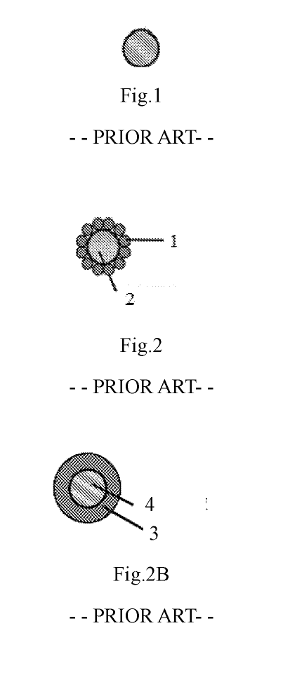

### DETAILED DESCRIPTION OF THE EMBODIMENTS

The present invention will now be descried more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

As previously mentioned, the composites constituted by inorganic and organic particles used in the conventional chemical mechanical polishing slurry requires complicated manufacturing processes and high cost, and the distribution of the inorganic particles on the organic particle surface is difficult to control. Thus, the present invention provides a chemical mechanical polishing slurry comprising a chemical solution, and organic particles and inorganic particles suspended in the chemical solution. The chemical solution also includes surfactants attached to the surfaces of the organic particles and the inorganic particles to separate the organic particles and the inorganic particles so as to make a full use of the advantages of both their own. In addition, the organic particles are formed by polymerized monomers of long chains and/or nebular core-shells by which the contact areas between the organic particles and the polished materials can be enlarged. Furthermore, the chemical mechanical polishing slurry of the present invention can be easily fabricated by the conventional polymerization techniques with a simple process and a low production cost. Besides that, the chemical mechanical polishing slurry of the present invention is particularly suitable for polishing the surfaces of relative soft materials such as the low-K materials, copper, or aluminum.

It should be noted that the polymerized monomers of the organic particles of the present invention are formed in at least the long chains and their combination, the nebular core-shells and their combination, and the combination of the long chains and the nebular core-shells. For example, the nebular core-shell structure comprises a nebular shell constituted by several monomers and a core constituted by one monomer; the core and the shell are polymerized to form the nebular core-shell structure of the organic particles. For another example, the long chain structure is formed by a line of polymerized monomers; the organic particles can be formed by a single long chain structure or a dendrimer-like structure or comb-like structure formed by polymerizing multiple long chain structures.

Since the organic particles are less prone to scratch the surfaces of the polished materials, the content of the organic particles is higher than that of the inorganic particles according to one embodiment of the present invention, so as to reduce the polishing scratches and residues caused by the inorganic particles. Preferably, the content of the organic particles is three to ten times higher that of the inorganic particles, and the total content of the organic particles and inorganic particles in the chemical mechanical polishing slurry is from 5 wt % to 25 wt %. For example, the content of the organic particles in the chemical mechanical polishing slurry is from 5 wt % to 20 wt % and that of the inorganic is 0.5 wt % to 5 wt %.

In the present invention, the organic particles can be formed by bulk polymerization, suspension polymerization, emulsion polymerization, solution poly-merization, ionic polymerization, coordination polymerization, melt polymerization, interfacial polycondensation and interfacial polycondensation. For example, in the polymerization of the monomers, the molecular weight of the monomer is from 500 to 50000; the detailed process parameters can be designed according to the demand of the actual process. The size of the organic particle is important as it affects the chemical mechanical polishing in the following ways: if the size is too small, the polishing rate will seriously decrease; while if the size is too large, the stability and dispersibility of the particles will be affected. Preferably, the size of the organic particle is from 50 nm to 400 nm.

The monomers forming the long chain structure each comprises multiple material layers of different hardness distributed from the outer surface to the inner center, wherein the hardness of the outmost material layer is the lowest. With such long chain structures, the contact areas between the organic particles and the polished materials can be enlarged, the polishing scratches on the surface of the materials can be reduced by the relative soft outer surface of the monomers, and the lower polishing efficiency due to the conventional soft organic particles can be increased by the relative hard inner center. Preferably, the Shores hardness of the outmost material layer is from 60A to 90A and that of the material layer of the inner center is higher than 60A and not higher than 130A. It should be noted that the unit of the hardness is Shores hardness in the present invention. The material layers of different hardness can be formed by causing chemical reactions among different organic materials, such as the grafting reaction.

The nebular core-shell structure that forms the organic particles comprises a nebular shell and a core. The Shore hardness of the shell is lower than that of the core. With such nebular core-shell structure, the contact areas between the organic particles and the polished materials can be enlarged, the polishing scratches on the surface of the polished materials can be reduced by the relative soft surface, the reduced polishing efficiency due to the conventional soft organic particles can be increased by the relative hard inner center. Preferably, the Shore hardness of the shell is from 80 to 90A and that of the core is higher than 80A and not higher than 130A.

The material of the organic particles is selected from at least one of polyethylene, polypropylene, polyvinyl chloride, polystyrene, acrylonitrile-butadiene-styrene terpolymer, polycarbonate, polyphenylene, polyphenylene sulfide, polymethylm-ethacrylate, polyethylene terephthalate, polybutylene terephthalate, polyurethane, polyetheretherketon, phenol formaledlyde, urea-formaldehyde resin, and epoxy resin.

The size of the inorganic particles should correspond to that of the organic particles so as not to cause serious scratches to the polished surfaces. The size of the inorganic particles of the present invention is from 30 nm to 200 nm. The material of the inorganic particles is selected from at least one of alumina, titanium oxide, zirconium oxide, silicon oxide, cerium oxide, and tantalum oxide.

The chemical solution also includes multiple surfactants attached to the surfaces of the organic particles and the inorganic particles according to the present invention. The surfactants isolate the organic particles from the inorganic particles so as not to cause inter attachment and agglomeration, which ensures a stable suspension. In general, the surfactants have both hydrophobicity and hydrophilicity and can be classified into different types such as the anionic surfactant, the cationic surfactant, the nonionic surfactant, the ampholytic surfactant or the polymeric surfactant. Due to the electrostatic repulsive force caused by an electric double layer or the steric hindrance of polymer, the organic particles and inorganic particles can be suspended stably in the chemical solution. Since it is well-known by those skilled in the art how to make the organic or inorganic particles suspended in the chemical solution by the surfactants, the detailed description is omitted herein.

The chemical solution can further include pH modifier for modifying the pH value of the chemical mechanical polishing slurry in a certain range. The pH modifier can be chosen according to the pH value required by the organic particles and the inorganic particles. The pH value of the present invention can be between 2 and 12, and the pH modifier can be selected from KOH, NH₃·H2O, HNO₃ or HCl.

It should be noted that the organic particles and the inorganic particles in the chemical mechanical polishing slurry of the present invention can be fabricated by any conventional methods. The organic particles can be fabricated by different monomer polymerizations, such as the bulk polymerization, the suspension polymerization, the emulsion polymerization, the solution polymerization, the ionic polymerization, the coordination polymerization, the melt polymerization, or the interfacial polycondensation. During the polymerization process, various polymerization initiators can be used to modify the hardness and the structure of the organic particles, so as to promote the polymerization of the monomers to form the organic particles having a shape of long chains or the nebular core-shells or their combinations. The polymerization initiators can be classified into different types such as the radical initiator, the anionic initiator, and the cationic initiator. The inorganic particles and the chemical solution can be fabricated by the conventional methods. Therefore, the chemical mechanical polishing slurry of the present invention can be easily fabricated with a low production cost.

### First Embodiment

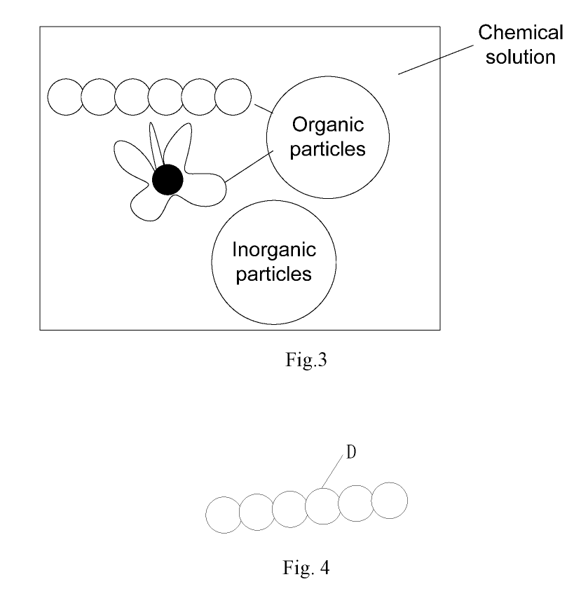

The chemical mechanical polishing slurry will be described in further details hereinafter with the embodiments and FIGS. 3 to 6. FIG. 3 is a schematic diagram of the composition of the chemical mechanical slurry of the present invention; FIGS. 4 to 6 are views of the organic particles according to the first embodiment of the present invention. The drawings are not necessarily to scale, emphasis instead being placed upon illustrating the principles of the present invention.

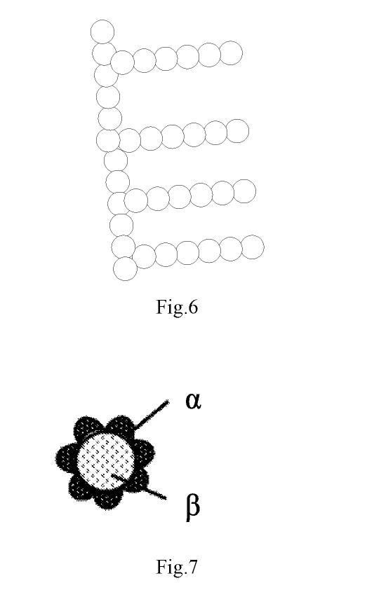

Referring to FIGS. 3 to 6, the chemical mechanical polishing slurry of the embodiment comprises chemical solution, organic particles and inorganic particles which are suspended in the chemical solution. The organic particles utilize monomer-polymerized long chain structures and their combination, which include the single long chain structures (as shown in FIG. 4), the dendrimer-like structures (as shown in FIG. 5) and the comb-like structures (as shown in FIG. 6) which are constituted by the long chain structures. The composition of the monomers is polyvinyl chloride (PVC).

The PVC organic particles are formed by suspension polymerization according to the embodiment. The structure of the monomer D is sphere but is not limited thereto. The sphere monomers D are polymerized by different polymerization initiators including the α-cumyl peroxyneodecanoate or the di-(2-ethylhexyl) peroxydicarbonate to form the long chain structures. The dendrimer-like and the comb-like structures are formed by recombining the long chain structures.

Compared with the single sphere organic particles, the PVC organic particles have a shape of the long chains can enlarge the contact areas between the organic particles and the surface of the polished material so as to improve the polishing efficiency. Preferably, the quantity of the sphere PVC monomers contained in one organic particle is from 10 to 200. The content of the organic particles formed by the long chain structures in the chemical mechanical polishing slurry is 20 wt %.

The PVC organic particle has a relative soft elastic surface, and thus the surface of the polished material will not be scratched during the polishing process. Preferably, the Shore hardness of the surface of the PVC organic particle is from 80A to 90A. Furthermore, since the PVC organic particles have stable chemical property, low metal ion content, and good chemical corrosion resistance, impurities will not be brought into the polishing process.

In addition, each of the monomers of the long chain structure can have multiple material layers of different hardness according to the present invention. The outmost material layer has the lowest hardness. For example, for a monomer of two different material layers from its outer surface to its inner center, the Shore hardness of the outmost material layer is from 80A to 90A and that of the inner material layer is from 90A to 130A.

The composition of the inorganic particles according to the embodiment is cerium oxide and the size of the inorganic particles is from 80 nm to 120 nm. The content of a single kind of abrasive particles in the conventional chemical mechanical polishing slurry is higher than 10%, while the content of the inorganic particles according to the embodiment is 5 wt %. The significantly decreased content of the inorganic particles can facilitate the stability of the entire system and effectively suppress the occurrence of the polishing scratches.

The chemical solution according to the embodiment further includes nonionic surfactants such as the alkylphenol ethoxylates. The nonionic surfactants are attached to the surfaces of the organic particles and inorganic particles respectively by the hydrophobicity and hydrophilicity so as to regulate the zeta potential at the organic and inorganic particles surfaces and prevent the two kinds of particles from attaching and agglomerating with each other, thereby forming a stable suspension.

The chemical solution according to the embodiment also includes pH modifiers comprising ammonia, potassium hydroxide, and organic alkali, thus to keep the pH value of the chemical mechanical slurry between 8.0 and 11.0.

The chemical mechanical polishing slurry can be applied to polish the low-K materials such as the black diamond series, which can significantly reduce the polishing scratches on the surfaces of the materials and keep a relative high polishing rate.

### Second Embodiment

The chemical mechanical polishing slurry according to the present invention will be described in further details hereafter with the embodiments and FIG. 3 and FIG. 7. FIG. 7 is a view of the organic particle according to the second embodiment of the present invention.

Referring to FIG. 3 and FIG. 7, the chemical mechanical polishing slurry according to the embodiment includes chemical solution, organic particles and inorganic particles which are suspended in the chemical solution. The organic particles are formed by polymerized monomers of nebular core-shells and their combination, which comprises the single nebular core-shell, and/or their combination formed by polymerizing the nebular core-shells, such as the dendrimer-like structures, the comb-like structures and so on.

In the embodiment, the nebular core-shell organic particles are formed by bulk polymerization, and the polymerization initiator is benzoyl peroxide.

Referring to FIG. 7, the composition of the core β is styrene and that of the shell a is butadiene, which form a polystyrene organic particle. The content of the nebular core-shell organic particles in the chemical mechanical polishing slurry is 0 wt % with the molecular weights from 1000 to 50000; the Shore hardness of the butadiene shell a is from 80A to 90A. The polishing rate of the organic particles decreases along with the hardness decline. To keep relative high polishing rate, the hardness of the styrene core β is higher than that of the butadiene shell a and is from 90A to 110A.

The advantages of using such organic particles are as follows: firstly, the polishing scratches on the polished materials can be further prevented by the relative softer shell, and the polishing rate can be improved by the relative hard core; secondly, compared with the sphere organic particles, the nebular organic particles can significantly enhance the contact areas between the organic particles and the polished materials surfaces, so as to apply moderate friction to the polished material surfaces and increase the polishing efficiency; furthermore, the polystyrene organic particles have excellent chemical corrosion resistance, chemical performance and low metal ion content, which will not bring any impurities to the polishing process.

In the embodiment, the inorganic particles are colloidal silica particles with the size of 80 nm and the content of 2 wt % in the chemical mechanical polishing slurry. The decreased content of the inorganic particles can reduce the polishing scratches on the polished materials caused by the inorganic particles.

The chemical solution according to the embodiment includes ampholytic surfactants such as the polysorbate, and anionic surfactants such as the sodium dodecyl sulfate, which regulates the zeta potential at the surfaces of the organic particles and the inorganic particles to prevent the two kinds of particles from attaching and agglomerating with each other, thereby forming a stable suspension.

The chemical solution also includes pH modifiers comprising hydrochloric acid, nitric acid, and organic acid to keep the pH value of the chemical mechanical polishing slurry between 2.0 and 5.0.

Such chemical mechanical polishing slurry according to the embodiment can be applied to polish relative soft metal materials such as copper, aluminum and so on, and can significantly suppress the occurrence of the polishing scratches on the materials surfaces and keep a relative high polishing rate.

The chemical solution according to the present invention can further includes inhibitors, chelators, oxidizers, or plasticizers.

In summary, according to the chemical mechanical polishing slurry of the present invention, the organic particles are formed by polymerized monomers with long chains and/or nebular core-shells, which can reduce the polishing scratches on the polished materials surfaces and increase the contact areas between the organic particles and the polished materials so as to enhance the polishing efficiency. Furthermore, the content of the organic particles is adjusted to be higher than that of the inorganic particles so that the residues on the surface of the polished materials can be reduced. In addition, since the organic particles are separated from the inorganic particles by the surfactants attached to their surfaces, the chemical mechanical polishing slurry of the present invention can not only take advantages of the organic particles to reduce the polishing scratches and residues on the materials surfaces, but also has the advantages of the inorganic particles to enhance the polishing rate. Besides that, the chemical mechanical polishing slurry of the present invention can be easily fabricated with a low production cost.

While this invention has been particularly shown and described with references to preferred embodiments thereof, if will be understood by those skilled in the art that various changes in form and details may be made herein without departing from the spirit and scope of the invention as defined by the appended claims. The draws are not necessarily to scale, emphasis instead being placed upon illustrating the principles of the present invention.

1. A chemical mechanical polishing slurry including:
chemical solution;
organic particles and inorganic particles suspended in the chemical solution;
wherein the organic particles are formed by polymerized monomers with long chains and/or nebular core-shells;
wherein the chemical solution contains surfactants attached to the surfaces of the organic particles and the inorganic particles which separate the organic particles from the inorganic particles.

2. The chemical mechanical polishing slurry according to claim 1, wherein the content of the organic particles is three to ten times higher than that of the inorganic particles; the total content of the organic particles and the inorganic particles in the chemical mechanical polishing slurry is from 5 wt % to 25 wt %.

3. The chemical mechanical polishing slurry according to claim 1, wherein the molecular weight of the monomer in the organic particle is from 500 to 50000; the size of the organic particles is from 50 nm to 400 nm.

4. The chemical mechanical polishing slurry according to claim 1, wherein the nebular core-shell is composed of a nebular shell and a core; the Shore hardness of the nebular shell is lower than that of the core.

5. The chemical mechanical polishing slurry according to claim 4, wherein the Shore hardness of the nebular shell is from 80A to 90A, and the Shore hardness of the core is higher than 80A and lower than 130A.

6. The chemical mechanical polishing slurry according to claim 1, wherein in the long chain, each of the monomers has multiple material layers of different hardness distributed from the outer surface to the inner center, wherein the outmost material layer has the lowest hardness.

7. The chemical mechanical polishing slurry according to claim 6, wherein the Shore hardness of the outmost material layer is from 60A to 90A; the Shore hardness of the inner center material layer of is higher than 60A and not higher than 130A.

8. The chemical mechanical polishing slurry according to claim 1, wherein the material of the organic particles is selected from at least one of the following: polyethylene, polypropylene, polyvinyl chloride, polystyrene, acrylonitrile-butadiene-styrene terpolymer, polycarbonate, polyphenylene, polyphenylene sulfide, polymethyl-methacrylate, polyethylene terephthalate, polybutylene terephthalate, polyurethane, polyetheretherketon, phenol formaledlyde, urea-formaldehyde resin, and epoxy resin.

9. The chemical mechanical polishing slurry according to claim 1, wherein the surfactants have both the hydrophobicity and hydrophilicity.

10. The chemical mechanical polishing slurry according to claim 1, wherein the size of the inorganic particles is from 30 nm to 200 nm; the material of the inorganic particles is selected from at least one of alumina, titanium oxide, zirconium oxide, silicon oxide, cerium oxide, and tantalum oxide.

11. The chemical mechanical polishing slurry according to claim 1, wherein the organic particles are formed by bulk polymerization, suspension polymerization, emulsion polymerization, solution polymerization, ionic polymerization, coordination polymerization, melt polymerization, interfacial polycondensation or interfacial polycondensation.
